(19) United States
(12) Patent Application Publication
(10) Pub. No.: US 2012/0151343 A1
(43) Pub. Date: Jun. 14, 2012

(54) DEEP TAGS CLASSIFICATION FOR DIGITAL MEDIA PLAYBACK

(75) Inventors: Robert Garner, Miami Beach, FL (US); Ernesto Morales, Miami, FL (US)

(73) Assignee: Deep Tags, LLC, Miami Beach, FL (US)

(21) Appl. No.: 12/966,671

(22) Filed: Dec. 13, 2010

(51) Int. Cl. G06F 3/01

(52) U.S. Cl. 715/716

(57) ABSTRACT

In an embodiment of the invention, a method for deep tag media playback is provided. The method includes activating a user interface control for a media player executing in memory of a computer and correlating the user interface control to a classification of content type for digital media. A starting frame of digital media loaded for playback in the media player is determined for the correlated classification and the digital media is indexed to the starting frame in the media player. Finally, playback of the digital media is directed in the media player beginning with the starting frame. Optionally, a proximity event can be detected for the user interface control. In response, a thumbnail image is generated based on the starting frame and the thumbnail image is displayed in proximity to the user interface control.

### BACKGROUND OF THE INVENTION

1. Field of the Invention

The present invention relates to the field of digital media playback and more particularly to scene indexing in a digital film.

2. Description of the Related Art

People began watching films and movies in the nineteenth century. With the advent of video cassettes and at-home players, such as videocassette recorders (VCRs), people now enjoy the viewing of movies from the comfort of their homes. A distinct advantage of viewing film at home on a playback device like a VCR is that the viewer can select a particular portion or scene of the film for viewing without being required to view the film in its entirety, which would be the case if the film were viewed in a theater environment. In order to watch a specific scene of a film using a VCR, the scene must first be located. Mechanically, this requires, a tedious trial and error struggle with fast-forward and rewind to locate the desired scene.

The advancement of technology and replacement of VCR technology with Digital Video Disc or Digital Versatile Disc (DVD) technology facilitated the finding of a specific scene in digital media easier through the use of a scene selection menu option in the main DVD menu. The scene selection option permits a display of an index of scenes by name in response to the selection of which directs the playback of the DVD from the selected scene. Necessarily then, the scene selection option of a DVD narrows the number of scenes necessary to watch before finding a specific scene.

With the internet and electronic distribution of content, people now can watch all types of media, including, but not limited to, film and television shows over the internet. Most media players on the internet provide playback options, including a slider user interface control to control the frame being viewed and played back, but a user must still use trial and error to find a specific scene or specific part of a movie. Combined with scene selection type functionality, the end user can locate a known scene by name very rapidly. In the absence of a priori knowledge of the desired scene, however, locating scenes of a particular type remains an ad hoc, trial and error process not much different from that required by a VCR. Yet, with access to so much media content over the internet, media watchers only want to watch certain scenes of a movie or television show relating to a specific theme, such as car crash scenes for racing enthusiasts, instances of fumbles for football enthusiasts, or dance scenes in a movie or television show for dance enthusiasts.

### BRIEF SUMMARY OF THE INVENTION

Embodiments of the invention provide for a system, a computer program product, and a method for deep tag navigation of digital media. In an embodiment of the invention, a method for deep tag media playback is provided. The method includes activating a user interface control for a media player executing in memory of a computer and correlating the user interface control to a classification of content type for digital media. A starting frame of digital media loaded for playback in the media player is determined for the correlated classification and the digital media is indexed to the starting frame in the media player. Finally, playback of the digital media is directed in the media player beginning with the starting frame. Optionally, a proximity event can be detected for the user interface control. In response, a thumbnail image is generated based on the starting frame and the thumbnail image is displayed in proximity to the user interface control.

Another embodiment of the invention provides a media playback system configured for deep tag navigation of digital media. The system can include a computer configured to support a content browser and a media player. The system can further include a deep tags media playback classifications module. The deep tags media playback classifications module can include program code for selecting a classification, determining a starting frame for the selected classification, indexing to the starting frame, and directing playback of the media. Also, the media playback classifications module can include program code for generating a thumbnail image based on the starting frame and displaying the thumbnail image.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for deep tag playback of digital media;

FIG. 2 is a schematic illustration of a media playback computer system configured for deep tag playback of digital media;

FIG. 3A is a flow chart illustrating a process for deep tag media playback; and,

FIG. 3B is a flow chart illustrating a process for thumbnail imagery display during deep tag media playback.

### DETAILED DESCRIPTION OF THE INVENTION

In accordance with an embodiment of the invention, deep tag media playback can be provided. In deep tag media playback, different user interface controls can be arranged in conjunction with a display of a media player through which digital media can be played back. Each user interface control can be defined according to a different classification of scene type and linked to an index of a scene in the digital media that is consistent with the classification. Each user interface control further can be configured to respond to activation by directing playback of the digital media in the display from a corresponding indexed scene. Optionally, each user interface control can be further configured to respond to a proximity or selection event by directing rendering of a thumbnail image of the corresponding indexed scene. In this way, though a viewer may not know of specific scene content in digital media, the viewer can elect to advance viewing of the digital media to scene content consistent with a particular classification of scene type, such as “car crashes”, “fumbles”, “dancing scenes” and the like.

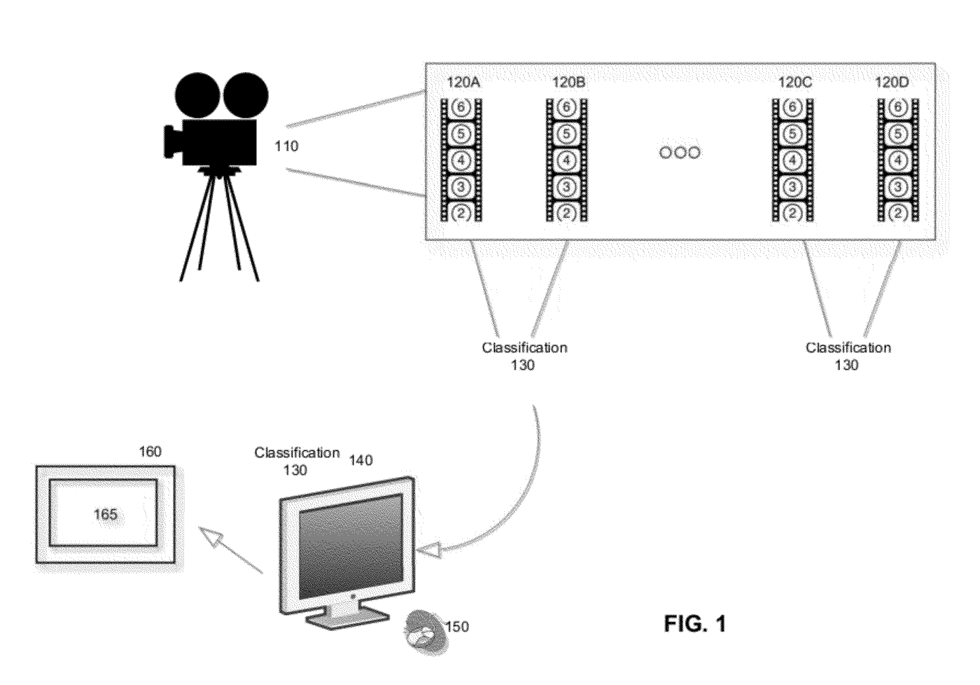

In further illustration, FIG. 1 pictorially shows a process for deep tag playback of digital media. As shown in FIG. 1, digital media 110 such as a film or video, is composed of a multiplicity of frames 120A, 120B, 120C, 120D. The frames 120A, 120B, 120C, 120D can be grouped into different classifications 130 based on the nature of the images or content contained in the frames 120A, 120B, 120C, 120D. For example, a classification 130 can include “fighting” for frames 120A, 120B, 120C, 120D containing imagery of a fight, or “interception” for frames 120A, 120B, 120C, 120D depicting the interception of a football during a football game. Each of the different classifications 130 can be associated with a control element (not shown) placed in proximity to a media player 140 configured to play back the digital media 110 such that the activation of the control element results in a selection of the particular one of the classifications 130 associated with the control element.

In response to the selection of a particular one of the classification 130 by way of the activation of a corresponding control element, the frames 120A, 120B, 120C, 120D associated with the selected one of the classifications 130 can be played back in the media player 140. Optionally, as a pointing device 150 comes into proximity of a user interface control for a selected one of the classifications 130, or when a user interface control for a selected one of the classifications 130 is activated, a thumbnail image 160 of one or more of the frames 120A, 120B, 120C, 120D corresponding one of the classifications 130 can be rendered in a thumbnail imagery display 165 in association with the user interface control for the selected one of the classifications 130.

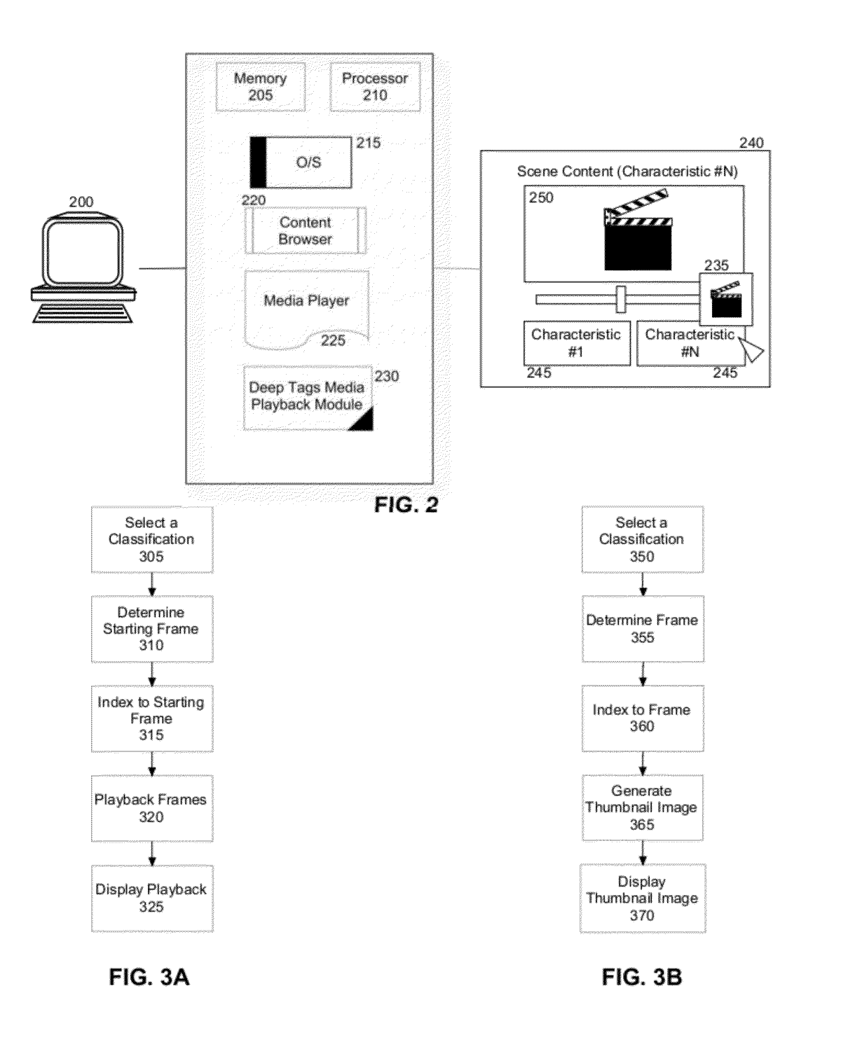

The process described in connection with FIG. 1 can be implemented in a media playback computer system. In further illustration, FIG. 2 is a schematic illustration of a media playback computer system configured for deep tag playback of digital media. The system can include a computer 200. The computer can include at least one processor 210 and memory 205. An operating system 215 can execute in the memory 205 of the computer 200 by at least one processor 210 of the computer 200. The operating system 215 can host the operation of a content browser 220, such as a web browser or an Internet browser. Further, a media player 225 can execute in conjunction with the display of content in the content browser 220.

Of note, a deep tags media playback classifications module 230 can execute in the memory 205 of the computer and can be coupled to the media player 225. The deep tags media playback classifications module 230 can include program code that when executed by at least one processor 210 of the computer 200 responds to the activation of a user interface control 245 for a display 240 of the media player 225 playing back frames of digital media 250, by determining a corresponding classification for the activated one of the user interface controls 245 and for directing the media player 225 to playback those frames of the digital media 250 associated with the corresponding classification. Further, the program code of the deep tags media playback module 230 when executed by at least one processor 210 of the computer 200 can render a thumbnail image of one or more frames of the digital media 250 corresponding to a particular classification in response to a mouse-over event or a selection event for a user interface control 245 associated with the particular classification so as to provide a “preview” of the frames of the digital media 250 for the particular classification.

In yet further illustration of the operation of the deep tags media playback module 230, FIG. 3A is a flow chart illustrating a process for deep tag media playback. Beginning in block 305, a user interface control corresponding to a particular classification can be selected. In block 310, the starting frame (the first frame) for the digital media associated with the particular classification is determined. For instance, a table can be maintained correlating a selected classification with a starting frame of specific digital media. Optionally, the final frame of the digital media for the user-selected classification is determined. Electively, the total length of the digital media for the user-selected classification is determined. The starting frame is indexed in a digital media player in block 315. In block 320, the digital media associated with the user-selected classification is played back from the starting frame. Finally, in block 325, the play back of the digital media associated with the user-selected classification is displayed in the media player.

Turning now to FIG. 3B, a flow chart is provided illustrating a process for thumbnail imagery display during deep tag media playback. Beginning in block 350, a proximity event such as a mouse-over or selection event for a user interface control corresponding to a particular classification is detected. In block 355, at least one frame associated with the particular classification is determined. In block 360, the frame associated with the user-selected classification is indexed. In block 365, a thumbnail image of the frame associated with the particular classification is generated. For example, the thumbnail image can include a frame associated with the particular classification, such as the first frame or one or more following frames from the first frame. Finally, in block 370, the thumbnail image is displayed in a thumbnail imagery display in association with the user.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s).

It should be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Also note that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process, such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for deep tag media playback comprising:
activating a user interface control for a media player executing in memory of a computer;
correlating the user interface control to a classification of content type for digital media;
determining a starting frame of digital media loaded for playback in the media player for the correlated classification;
indexing the media to the starting frame in the media player; and,
directing playback of the media in the media player beginning with the starting frame.

2. The method of claim 1, further comprising:
detecting a proximity event for the user interface control;
generating a thumbnail image in response to the proximity event based on the starting frame; and,
displaying the thumbnail image in proximity to the user interface control.

3. The method of claim 2, wherein detecting a proximity event for the user interface control, comprises detecting a mouse-over event for the user interface control.

4. The method of claim 2, wherein detecting a proximity event for the user interface control, comprises detecting a selection event for the user interface control.

5. A computer program product for deep tag playback of digital media the computer program product comprising:
a computer readable storage medium having computer readable program code embodied therewith, the computer readable program code comprising:
computer readable program code for activating a user interface control for a media player;
computer readable program code for correlating the user interface control to a classification of content type for digital media;
computer readable program code for determining a starting frame of digital media loaded for playback in the media player for the correlated classification;
computer readable program code for indexing the media to the starting frame in the media player; and,
computer readable program code for directing playback of the media in the media player beginning with the starting frame.

6. The computer program product of claim 5, further comprising:
computer readable program code for detecting a proximity event for the user interface control;
computer readable program code for generating a thumbnail image in response to the proximity event based on the starting frame; and,
computer readable program code for displaying the thumbnail image in proximity to the user interface control.

7. The computer program product of claim 6, wherein the computer readable program code for detecting a proximity event for the user interface control, comprises computer readable program code for detecting a mouse-over event for the user interface control.

8. The computer program product of claim 6, wherein the computer readable program code for detecting a proximity event for the user interface control, comprises computer readable program code for detecting a selection event for the user interface control.

9. A media playback data processing system configured for deep tag navigation of digital media comprising:
a computer with at least one processor and memory;
a content browser executing in the computer;
a media player displayed in the content browser; and
a deep tags playback module coupled to the media player, the module comprising program code enabled to activating a user interface control for a media player, to correlate the user interface control to a classification of content type for digital media, to determine a starting frame of digital media loaded for playback in the media player for the correlated classification, to index the media to the starting frame in the media player, and to direct playback of the media in the media player beginning with the starting frame.

10. The system of claim 9, wherein the program code of the deep tags playback module is further enabled to detect a proximity event for the user interface control, to generate a thumbnail image in response to the proximity event based on the starting frame, and to display the thumbnail image in proximity to the user interface control.

11. The system of claim 10, wherein the proximity event is a mouse-over event.

12. The system of claim 10, wherein the proximity event is a selection event.
